(19) United States
(12) Patent Application Publication
(10) Pub. No.: US 2009/0312888 A1
(43) Pub. Date: Dec. 17, 2009

(54) DISPLAY OF A RELEVANT TRAFFIC SIGN OR A RELEVANT TRAFFIC INSTALLATION

(76) Inventors: Stefan SICKERT, Ludwigsburg (DE); Jens Schick, Herrenberg (DE); Bernd Richter, Kleinberghofen (DE)

Correspondence Address: KENYON & KENYON LLP, ONE BROADWAY, NEW YORK, NY, 10004, US

(21) Appl. No.: 12/331,739

(22) Filed: Dec. 10, 2008

(30) Foreign Application Priority Data
Feb. 25, 2008 (DE) 10 2008 010 968.1

(51) Int. Cl. G06F 7/00; G01C 21/36

(52) U.S. Cl. 701/1

(57) ABSTRACT

In a method for displaying information in a vehicle: a region of the surroundings of the vehicle is captured optically via at least one image capture device; the captured image data are transmitted to a control and analysis unit, which analyzes the captured image data for the presence of traffic signs or traffic installations; and information is displayed on a display unit in the vehicle if the captured image data following analysis on the part of the control and analysis unit contain at least one traffic sign and/or at least one traffic installation. The control and analysis unit is supplied with route information about the current or planned route of the vehicle, information adapted to the current or planned route of the vehicle being displayed if for different route options different traffic signs and/or different traffic installations are detected.

### CROSS-REFERENCE TO RELATED APPLICATIONS

The present application claims priority to Application No. 10 2008 010 968.1, filed in the Federal Republic of Germany on Feb. 25, 2008, which is expressly incorporated herein in its entirety by reference thereto.

### FIELD OF THE INVENTION

The present invention relates to a display of a relevant traffic sign or a relevant traffic installation.

The present invention relates to a method for assisting the driver of a motor vehicle in recognizing the surroundings of the motor vehicle, the surroundings of the motor vehicle in particular in front of the vehicle being recorded optically by one or several image capture devices situated in or on the vehicle and the thus captured image data being analyzed by a control and analysis unit as to whether they contain traffic signs and/or traffic installations, and at least one item of information being visually represented in a display unit, for example in an instrument cluster of the vehicle if the latter is the case. Traffic installations may be in particular barriers, bollards, railings, blocking devices, guiding installations and flashing light or light signal systems.

Any type of image sensor, preferably video cameras that record in black and white or in color, may be used as an image capture device. Thus the use of video-based driver assistance systems, for example, which display images recorded by a camera on a display, is known for assisting the drivers of motor vehicles. In this manner it is possible, for example, to assist the driver in detecting parking space boundaries or obstacles using a backup camera system when reverse parking. By using infrared-sensitive image sensors, as shown in WO 2004/047449, for example, the driver may also be effectively assisted in connection with so-called night view systems even in conditions of poor visibility or poor weather conditions.

### BACKGROUND INFORMATION

DE 102 49 512 describes a vehicle having a device for detecting a current traffic light signal. In this instance, the traffic light signal emitted by a traffic light may be detected by a color-sensitive light receiver, for example an optical sensor or a color camera, and may be analyzed by a control unit with the aid of an image processing program or in a color detection process. The current traffic light phase may then be communicated to the driver in particular visually, for example via colored light-emitting diodes. The captured images of the traffic light setting may also be represented on a display device.

The aforementioned methods and systems are used for assisting the driver in recognizing traffic installations such as traffic lights in that they display all detected traffic lights as an image or a corresponding symbol.

### SUMMARY

Example embodiments of the present invention provide a method of the type mentioned at the outset, which optimizes the assistance to the driver in recognizing traffic signs and/or traffic installations and offers the driver greater convenience.

Example embodiments of the present invention supply route information about the current or planned path or route of the vehicle to the control and analysis unit and display information adapted to the current or planned route of the vehicle as soon as for different route options different traffic signs and/or different traffic installations are detected.

The displayed information depends on the route of the vehicle. This makes it possible to reduce or avoid the display of information about traffic signs or traffic installations that are not relevant for the current or planned route, which is a considerable advantage. Particularly at forks or intersections, the driver is thus spared an unnecessary multitude of information, which represents a substantial gain in convenience especially in light of a constantly rising flood of information in the vehicle, and which increases the acceptance of such assistance systems.

For example, at an intersection having separate traffic signals for the left-hand turn-off lane on the one hand and the straight-ahead lane and right-hand turn-off lane on the other hand, information may be displayed to the driver that is adapted to the route planned by the driver such that the traffic light signals relevant for this purpose are especially emphasized or displayed exclusively. The display may also be adapted, for example, if traffic signs are detected that are provided with an additional sign that indicates that the traffic sign only applies to a certain driving direction and if the latter deviates from one's own route.

If identical traffic signs or identical traffic installations are detected for different route options, however, then an adaptation is not required. Likewise, the displayed information does not have to be specifically adapted if different traffic signs or different traffic installations are indeed detected, but only one possible route exists.

On the whole, an optimized method is provided that allows for a specific display of relevant and thus ensures a better assistance to the driver of a motor vehicle. The method thus results in a significant increase of user friendliness and thus also in a greater acceptance among the users of the respective driver assistance system.

It is particularly advantageous, for example, if solely the information is displayed that concerns the current or planned route of the vehicle. Thus, for this purpose, all information about detected traffic signs or traffic installations that concerns a driving direction deviating from the route of the vehicle is suppressed.

An example embodiment provides for information to be displayed if, in particular only if, the captured image data, following the analysis by the control and analysis unit, contain at least one traffic installation in the form of a light signal system, in particular a alternating light signal system or traffic light system. In particular because traffic lights are not always in the driver's field of vision and possibly require considerable contortions on the part of the driver, such a display of information about relevant traffic light signals is practical. In a corresponding manner, it is also possible, however, that other traffic installations, for example in the form of a barrier, are detected and corresponding information is displayed.

The current switching state of an alternating light signal device may be ascertained by the control and analysis unit and then information, particularly symbols, may be displayed that correspond to the current traffic light signal.

In addition to the specific display of the relevant information, the current traffic light signal applicable to the current or planned route of the vehicle, or the logical signaling state of this traffic light signal, may advantageously also be signaled to the driver in a visually and/or acoustically and/or haptically perceptible manner.

The information displayed may include a detail of the captured image data, which contains at least one detected relevant traffic sign or at least one relevant traffic installation. These image details may be displayed alone or in combination with other information about relevant information.

Example embodiments of the method provide for the control and analysis unit to be supplied with information about the current or planned route of the vehicle, which is transmitted from a navigation system of the vehicle. Thus it is possible to display specifically information about detected traffic signs and/or traffic installations that apply to the suggested route and thus to the direction of travel relevant for the vehicle, if the driver adheres to the route suggestions of the navigation system.

Example embodiments of the method provide for the control and analysis unit to be supplied with information about the current or planned route of the vehicle, which is transmitted from a lane detection system. Lane detection, for example, is able to determine that a vehicle is located in a left-hand turn-off lane such that in detecting multiple different traffic signs and/or traffic installations it is possible to display specifically only information about the traffic signs or traffic installations applicable to left-turning vehicles.

Example embodiments of the method provide for the control and analysis unit to be supplied with information about the current or planned path or route of the vehicle that takes into account the setting of a turn signal on the part of the driver. In the process, the information to be displayed may be specifically adapted to the driver's currently expressed wish to perform the intended change in the direction of travel.

The aforementioned variants may be implemented individually or in any combination and/or in combination with additional possibilities for detecting the current or planned route of the vehicle, which increases the accuracy of the adaptation accordingly. Thus, for the purpose of detecting the current or planned route of the vehicle, it is possible for example to analyze also additional information about the surroundings, for example the spatial direction, the size, directional arrows and/or GPS data.

The information may be displayed when the vehicle is at a standstill, particularly only when the vehicle is at a standstill. In this manner it is possible to prevent the driver from being distracted while driving.

Example embodiments of the present invention provide a driver assistance system for the specific display of relevant information in a vehicle, which is particularly suitable for implementing the method of type described above. Such a system includes at least one image capture device, a display unit and a control and analysis unit, which is connected to the image capture device and the display unit. Additionally, an information device or information system connected to the control and analysis unit is provided, which supplies the control and analysis unit with route information about a current or planned route of the vehicle such that, when detecting different traffic signs and/or different traffic installations for different route options, information is displayed on the display unit that is adapted to the current or planned route of the vehicle.

The system may make use of individual or multiple components of other system, for example the camera of a lane detection system or a night vision system, which reduces the costs accordingly.

Example embodiments of the present invention are described in greater detail below with reference to the appended Figures.

### BRIEF DESCRIPTION OF THE DRAWINGS

FIG. 1 illustrates n exemplary street scene including an intersection seen from the interior of a vehicle.

FIG. 2 is a schematic view of main components of a system for implementing method according to an example embodiment of the present invention.

### DETAILED DESCRIPTION

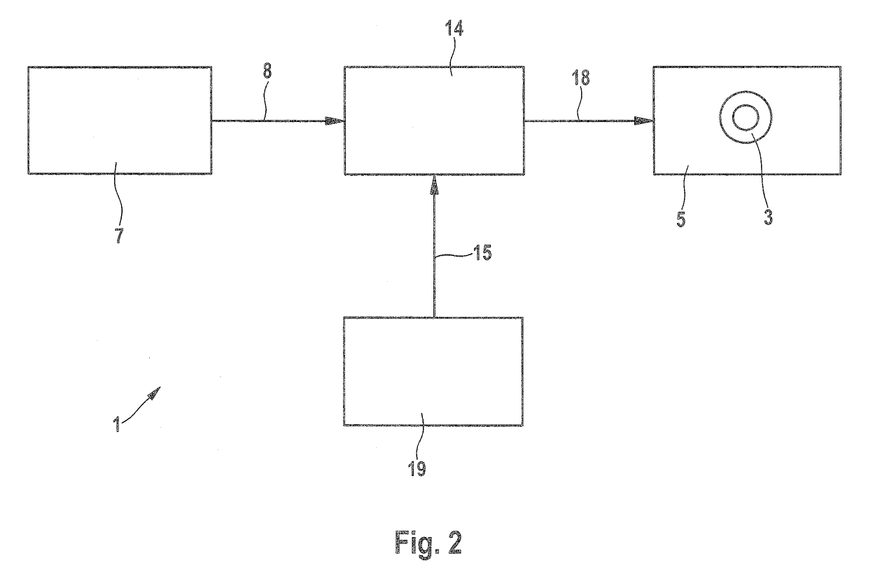

The method according to example embodiments of the present invention is explained with reference to driver assistance system 1 shown in FIG. 2, which is provided in a motor vehicle 2. For displaying information 3 about relevant traffic signs and/or traffic installations, a display unit 5 is situated in an instrument cluster 4 of vehicle 2, on which information 3 is displayed for example in the form of an image detail 6 of the image data 8 of the vehicle's surroundings captured by a video camera 7 shown in FIG. 2. A display or monitor provided in a different location may in particular also be used as display unit 5, however.

The captured surroundings in this case include especially a roadway 9 that leads into an intersection 10 a short distance away. For the host vehicle's own direction of travel, there are already two parallel lanes 9a and 9b, which are separated from each other by lane markings 11. Directional arrows 12a pointing left are applied on left lane 9a traveled by the depicted vehicle 2, while directional arrows 12b pointing right and straight-ahead are applied on right lane 9b situated to the right of vehicle 2. Since the route planned for vehicle 2 provides for a turning operation to the left at intersection 10, the vehicle is situated in the left-hand turn-off lane in left lane 9a. The opposite lane 9c of traffic in the oncoming direction is separated by lane markings 11.

At intersection 10 there is a traffic installation in the form of a traffic light system 13, which has a separate traffic light 13a and 13b for the two lanes 9a and 9b, respectively, by which separate signals may be displayed for each of the two lanes 9a and 9b. Both traffic lights 13a and 13b are captured by camera 7 and are identified by control and analysis unit 14 shown in FIG. 2 as a traffic installation that is potentially to be displayed. If both traffic lights 13a and 13b signal the same color, then a corresponding item of information 3 may be shown to the driver in display unit 5, which is then valid for both lanes 9a and 9b.

However, as soon as in the depicted situation traffic light 13a (red light) signals a traffic light phase that differs from the other traffic light 13b (green light), only an item of information 3 that corresponds to traffic light 13a and thus to the planned direction of travel 9a is to be displayed to the driver. For this purpose, control and analysis unit 14 is supplied with additional route information 15 which corresponds to the planned route of vehicle 2. Here, this route information 15, which stems from various sources, includes data from a navigation system 16 and data about the left blinker or direction indicator 17 activated by the driver.

In addition, a lane detection system may also determine that vehicle 2 is located in left lane 9a. Furthermore, the position and/or size of directional arrows 12a and 12b may be analyzed by image recognition methods and inferences may be drawn from this regarding the currently traveled lane 9a and thus also regarding the planned direction of travel.

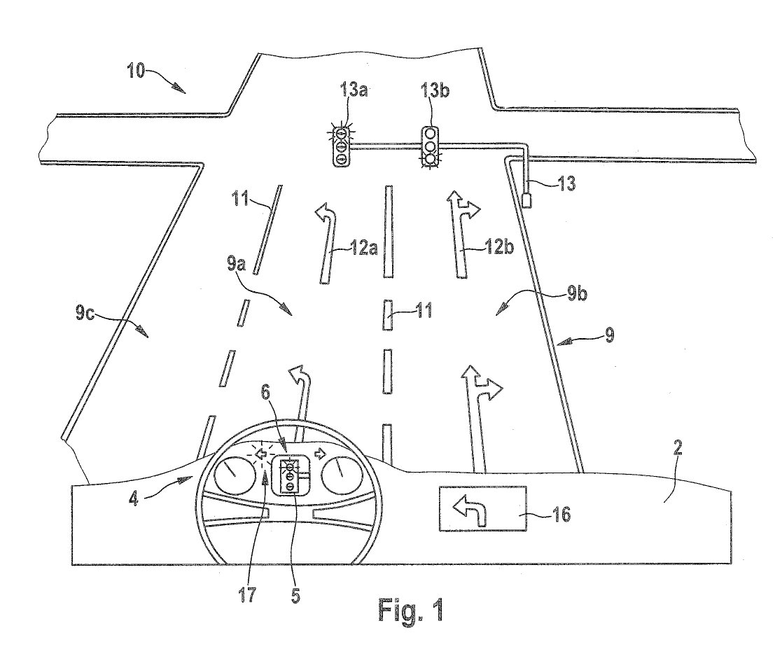

In any event, it is thus possible to display information 3 adapted to the current or planned route of vehicle 2 such that the driver advantageously receives only the information relevant for him when there are multiple detected traffic signs and/or traffic installations 13a, 13b that differ from one another. Hence, in the example shown in FIG. 1, only one item of information in the form of an image detail 6 is displayed to the driver in display unit 5, which image detail 6 contains the left traffic light 13a applicable to the lefts hand turn-off lane including the stop signal (red light) thereby signaled.

FIG. 2 shows components of system 1 of example embodiments of the present invention in a block diagram. A video camera 7 is used as the image capture device, which transmits the recorded image date 8 of the vehicle's surroundings to control and analysis unit 14. Following the analysis of these image data 8, in response to detecting relevant traffic signs or traffic installations 13, control and analysis unit 14 transmits corresponding display data 18 to display unit 5 in order to display corresponding information 3 to the driver. In order to be able to judge the relevance of the detected traffic signs or traffic installations 13 for the current or planned route of vehicle 2, control and analysis unit 14 is additionally connected to an information system 19, from which it is supplied with route information 15 regarding the current or planned route of vehicle 2. Information system 19 may include in particular information of a navigation system 16 and/or a lane detection system.

What is claimed is:

1. A method for displaying information in a vehicle, comprising:
optically capturing a region of surroundings of the vehicle via at least one image capture device;
transmitting captured image data to a control and analysis unit;
analyzing, by the control and analysis unit, the captured image data for presence of at least one of (a) traffic signs and (b) traffic installations;
displaying information on a display unit in the vehicle if the captured image data, following the analysis, includes at least one of (a) at least one traffic sign and (b) at least one traffic installation;
supplying the control and analysis unit with route information about at least one of (a) a current and (b) a planned route of the vehicle; and
displaying information adapted to at least one of (a) the current and (b) the planned route of the vehicle if, for different route options, at least one of (a) different traffic signs and (b) different traffic installations, are detected.

2. The method according to claim 1, wherein solely the information that concerns at least one of (a) the current and (b) the planned route of the vehicle is displayed.

3. The method according to claim 1, wherein information is displayed if the captured image data following the analysis includes at least one traffic installation in the form of at least one of (a) a light signal system and (b) an alternating light signal system.

4. The method according to claim 3, wherein a current switching state of an alternating light signal system is ascertained by the control and analysis unit and at least one of (a) corresponding information and (b) symbols are displayed.

5. The method according to claim 4, wherein a current traffic light signal applicable to at least one of (a) the current and (b) planned route of the vehicle is signaled to a driver in at least one of (a) a visually-, (b) an acoustically-, and (c) a haptically-perceptible manner.

6. The method according to claim 1, wherein the displayed information includes a detail of the captured image data.

7. The method according to claim 1, wherein the control and analysis unit is supplied with route information about at least one of (a) the current and (b) the planned route of the vehicle transmitted by a navigation system.

8. The method according to claim 1, wherein the control and analysis unit is supplied with route information about at least one of (a) the current and (b) the planned route of the vehicle transmitted by a lane detection system.

9. The method according to claim 1, wherein the control and analysis unit is supplied with route information about at least one of (a) the current and (b) the planned route of the vehicle, which detect an activation of a direction indicator.

10. The method according to claim 1, wherein the information is displayed when the vehicle is at a standstill.

11. A system for displaying information in a vehicle, comprising:
at least one image capture device;
a display unit;
a control and analysis unit connected to the image capture device and the display unit;
at least one of (a) an information device and (b) an information system connected to the control and analysis unit and adapted to supply the control and analysis unit with route information about at least one of (a) a current and (b) a planned route of the vehicle such that, when detecting at least one of (a) different traffic signs and (b) different traffic installations for different route options, information is displayable on the display unit that is adapted to at least one of (a) the current and (b) the planned route of the vehicle.

12. The system according to claim 11, wherein the system is adapted to perform the method according to claim 1.
